(19) United States
(12) Patent Application Publication
(10) Pub. No.: US 2013/0117862 A1
(43) Pub. Date: May 9, 2013

(54) METHOD OF AUTHENTICATING SUBSCRIPTION TO A MOBILE CONTENT SERVICE

(71) Applicants: Brian Patrick Farrell, County Louth (IE); Brian James O'Dwyer, County Dublin (IE); Tadgh Thomas O'Toole, Dublin 6 (IE)

(72) Inventors: Brian Patrick Farrell, County Louth (IE); Brian James O'Dwyer, County Dublin (IE); Tadgh Thomas O'Toole, Dublin 6 (IE)

(73) Assignee: MODEVA INTERACTIVE, County Dublin (IE)

(21) Appl. No.: 13/697,411

(22) PCT Filed: May 12, 2010
(86) PCT No.: PCT/EP10/56609

§ 371 Date: Jan. 22, 2013

(51) Int. Cl. H04L 29/06

(52) U.S. Cl. CPC H04L 63/08
USPC 726/29

(57) ABSTRACT

This invention relates to a method of authenticating subscription to a mobile content service. Currently, the known methods of authenticating subscription to a mobile content service are unsatisfactory due to their susceptibility to fraud and their complexity. The present invention obviates the problems with the known methods by introducing a third party Unique Identifier verifier 7 (TPV). The TPV 7 generates a Unique Identifier code on request of a service provider 5 (SP) and transmits the Unique Identifier code to a mobile communication device 9 (MCD). The MCD 9 then transmits this Unique Identifier code to the SP 5 who in turn verifies the Unique Identifier code with the TPV 7. If the TPV 7 verifies that the Unique Identifier code is authentic, the MCD 9 user is subscribed to the service. This method simplifies the existing methods and furthermore reduces the possibility of fraud.

This invention relates to a method of authenticating subscription to a mobile content service in a system comprising a service provider (SP), an independent third party verifier (TPV) and a mobile communication device (MCD).

There are numerous mobile content services available to users of mobile communication devices. Mobile content services offer content including, but not limited to, ring tones, wallpapers, pictograms, video, audio, text, streaming video, streaming audio and alerts. MCD users may subscribe to these services and be provided with content according to the mobile content service.

Usually, the mobile content service is a paid service requiring the subscriber to pay a fee for receiving the content. Therefore, when advertising mobile premium rate content services on-line, many local regulators, operators and advertising authorities insist that the provider of the service carry out a verification process to ensure that the person in possession of the MCD is authorising the subscription to the service and acknowledging their participation in the service.

Currently there are two known methods of authenticating subscription to a mobile content service. One common method of authenticating a subscription to a mobile content service is the so-called “Mobile Originated (MO) validation” method. According to this method, MCD users are required to confirm subscription to the service by actively replying to a short messaging service (SMS) message sent from the service provider, which contains details relating to the service. Typically, the MCD user enters their mobile phone number into an on-line form provided by the SP. The SP then sends a text message to the MCD and the MCD user is required to respond to the text message with “Yes” or equivalent confirmation of subscription to the service.

There are however problems with this method. First of all, it is quite common for an incorrect MCD number to be input by the MCD user during completion of the on-line form. This leads to another unsuspecting MCD user receiving an un-requested SMS message from the SP. This shortcoming may be taken advantage of by unscrupulous SPs in order to randomly promote their services to MCD users who have simply not requested them. Often the user is unable to tell if the SMS message that they receive relates to a service that has been requested or not and many MCD users unwittingly subscribe to mobile content services that they did not wish to subscribe to. A second problem with this method is that the MCD users are required to move from one technology platform (online forms) to another technology platform (SMS) in order to authenticate their subscription which is undesirable.

An alternative to the “MO validation” method is the so-called “PIN verification” method. According to the “PIN verification” method, the MCD user enters their MCD number into an on-line form provided by the SP and the SP prompts the MCD user to enter a PIN number for verification of the request to subscribe to the mobile content service. At the same time, the SP automatically generates an SMS message containing the PIN number which it sends to the MCD number that has been provided in the on-line form. The user enters the PIN number into the on-line form for verification.

According to the “PIN verification” method, a text message containing a four digit PIN number cannot promote a service, or in any way hold relevance or instruction for a user who has not requested it and this obviates the possibility of consumers unwittingly subscribing to services that they do not wish to subscribe to. This “PIN verification” method is seen as more secure, non-invasive and satisfies most regulatory concerns without presenting unnecessary barriers to the customer.

There are however also problems with the “PIN verification” method. Various jurisdictions do not allow “PIN verification” as a method of authentication due to the fact the SP is the operator of both the authentication process and the generation and delivery of the PIN number. Therefore, this method is not seen as an acceptable solution as fraud may be perpetrated by unscrupulous mobile content service providers subscribing MCD users to services that they did not wish to be subscribed to.

It is an object of the present invention to provide a method of authenticating subscription to a mobile content service that is secure and that overcomes at least some of the problems with the known methods.

### STATEMENTS OF INVENTION

According to the invention there is provided a method of authenticating subscription to a mobile content service in a system comprising a Service Provider (SP) computer, an independent Third Party Verifier (TPV) computer and a Mobile Communication Device (MCD), the method comprising the steps of: an MCD user submitting a MCD identifier to an SP; the SP computer transmitting a Unique Identifier code request incorporating the MCD identifier to the TPV computer; the TPV computer transmitting a Unique Identifier code to the MCD; the MCD user forwarding the Unique Identifier code to the SP computer; the SP computer transmitting the MCD identifier and the Unique Identifier code to the TPV computer for authentication of the Unique Identifier code; the TPV computer verifying whether the Unique Identifier code received from the SP computer is the same as the Unique Identifier code sent to the MCD and if so the TPV computer transmitting a Unique Identifier verification message to the SP computer; and on the SP computer receiving a Unique Identifier verification message, the SP computer subscribing the MCD to the mobile content service.

By having such a method, it is possible to overcome some of the problems with the known methods. First of all, it is not necessary for the MCD user to send an SMS to the SP to confirm subscription to the service. Secondly, due to the fact that a TPV is used to generate and verify a unique identifier code, the opportunity to mislead an MCD user by spamming and/or data entry error is significantly reduced.

In one embodiment of the invention, in addition to the MCD identifier, the SP computer transmits a string of text including a Unique Identifier placeholder, as part of the Unique Identifier code request.

In another embodiment of the invention, the step of the TPV computer transmitting a Unique Identifier code to the MCD further comprises the steps of: the TPV computer inserting the Unique Identifier code into the Unique Identifier placeholder in the string of text; and forwarding the string of text with the Unique Identifier code to the MCD.

In a further embodiment of the invention, in addition to the MCD identifier, the SP computer transmits at least one of a transaction ID and a description of the mobile content service, as part of the Unique Identifier code request.

In one embodiment of the invention, the TPV computer creates a log of the event including: a transaction ID, the Unique Identifier code request, an SP computer identifier, a time/date stamp, the Unique Identifier code and a record of transmission of the Unique Identifier code to the MCD.

In another embodiment of the invention, on the TPV computer verifying that the Unique Identifier code received from the SP computer is the same as the Unique Identifier code sent to the MCD, the TPV computer updates the log of the event with an indication of Unique Identifier verified status.

In a further embodiment of the invention, the step of the SP computer transmitting the Unique Identifier code to the TPV computer for authentication further comprises the SP computer transmitting, along with the Unique Identifier code, the transaction ID instead of or in addition to the MCD identifier to the TPV computer.

In one embodiment of the invention, the TPV computer transmits the Unique Identifier code to the MCD in a Short Messaging Service (SMS) message.

In another embodiment of the invention, the MCD user submits the MCD identifier by entering the MCD identifier into an SP online form.

In a further embodiment of the invention, the step of the MCD forwarding the Unique Identifier code to the SP computer comprises the MCD user entering the Unique Identifier code into the SP online form.

In one embodiment of the invention, the step of the MCD user forwarding the Unique Identifier code to the SP computer further comprises the MCD user forwarding their MSISDN to the SP along with the Unique Identifier code.

In another embodiment of the invention, the MSISDN and the Unique Identifier are encrypted prior to transmission to the SP.

In a further embodiment of the invention there is provided a method of authenticating subscription to a mobile content service in a system comprising a service provider (SP) computer, a remote independent Third Party Verifier (TPV) computer and a remote mobile communication device (MCD), the method comprising the steps of: the SP computer receiving an MCD identifier from a MCD; the SP computer transmitting a Unique Identifier code request incorporating the MCD identifier to the remote TPV computer; the SP computer receiving a Unique Identifier code from the MCD; the SP computer transmitting the MCD identifier and the Unique Identifier code to the TPV computer for authentication of the Unique Identifier code; the SP computer receiving a Unique Identifier verification message from the TPV computer on the TPV computer verifying the Unique Identifier code; and on the SP computer receiving the Unique Identifier verification message, the SP computer subscribing the MCD to the mobile content service.

In one embodiment of the invention, in addition to the MCD identifier, the SP computer transmits a string of text including a Unique Identifier placeholder, as part of the Unique Identifier code request.

In another embodiment of the invention, in addition to the MCD identifier, the SP computer transmits at least one of a transaction ID and a description of the mobile content service, as part of the Unique Identifier code request.

In a further embodiment of the invention, the step of the SP computer transmitting the Unique Identifier code to the TPV computer for authentication further comprises the SP computer transmitting, along with the Unique Identifier code, a transaction ID instead of or in addition to the MCD identifier to the TPV computer.

In one embodiment of the invention, the SP computer receives at least one of the MCD identifier and the Unique Identifier code from the MCD through an SP online form.

In another embodiment of the invention there is provided a method of authenticating subscription to a mobile content service in a system comprising an independent Third Party Verifier (TPV) computer, a remote service provider (SP) computer, and a remote mobile communication device (MCD), the method comprising the steps of: the TPV computer receiving a Unique Identifier code request incorporating an MCD identifier from the remote SP computer; the TPV computer transmitting a Unique Identifier code to the remote MCD; the TPV computer receiving the MCD identifier and the Unique Identifier code from the remote SP computer for authentication of the Unique Identifier code; and the TPV computer verifying whether the Unique Identifier code received from the remote SP computer is the same as the Unique Identifier code sent to the remote MCD and if so the TPV computer transmitting a Unique Identifier verification message to the remote SP computer.

In a further embodiment of the invention, in addition to the MCD identifier, the TPV computer receives a string of text including a Unique Identifier placeholder, as part of the Unique Identifier code request.

In one embodiment of the invention, the step of the TPV computer transmitting a Unique Identifier code to the remote MCD further comprises the steps of: the TPV computer inserting the Unique Identifier code into the Unique Identifier placeholder in the string of text; and forwarding the string of text and Unique Identifier code to the remote MCD.

In another embodiment of the invention, in addition to the MCD identifier, the TPV computer receives at least one of a transaction ID and a description of the mobile content service, as part of the Unique Identifier code request.

In a further embodiment of the invention, the TPV computer creates a log of the event including: the transaction ID, the Unique Identifier code request, a remote SP computer identifier, a time/date stamp, the Unique Identifier code and confirmation of transmission of the Unique Identifier code to the remote MCD.

In one embodiment of the invention, on the TPV computer verifying that the Unique Identifier code received from the remote SP computer is the same as the Unique Identifier code sent to the remote MCD, the TPV computer updates the log of the event with an indication of Unique Identifier verified status.

In another embodiment of the invention, the step of the TPV computer receiving the Unique Identifier code from the remote SP computer for authentication further comprises the TPV computer receiving, along with the Unique Identifier code, a transaction ID instead of or in addition to the MCD identifier from the remote SP computer.

In a further embodiment of the invention, the TPV computer transmits a Unique Identifier code to the remote MCD in a Short Messaging Service (SMS) message.

In one embodiment of the invention there is provided a method of subscribing to a mobile content service in a system comprising a remote service provider (SP) computer, a remote independent Third Party Verifier (TPV) computer and a mobile communication device (MCD), the method comprising the steps of: a MCD user submitting a MCD identifier to an SP; the MCD receiving a Unique Identifier code from the independent TPV computer; the MCD user transmitting the Unique Identifier code to the SP.

In another embodiment of the invention, the MCD receives the Unique Identifier code from the independent TPV computer in a Short Messaging Service (SMS) message.

In a further embodiment of the invention, the MCD user submits the MCD identifier by entering the MCD identifier into an SP online form.

In one embodiment of the invention, the MCD user transmits the Unique Identifier code by entering the Unique Identifier code into an SP online form.

In another embodiment of the invention there is provided a system for authenticating subscription to a mobile content service comprising a Service Provider (SP) computer, an independent Third Party Verifier (TPV) computer and a Mobile Communication Device (MCD), in which: the MCD has means for submitting a MCD identifier and forwarding a Unique Identifier code to the SP computer; the SP computer has means for transmitting a Unique Identifier code request incorporating the MCD identifier to the TPV computer, means for transmitting the MCD identifier and the Unique Identifier code to the TPV computer for authentication of the Unique Identifier code and means for subscribing the MCD to the mobile content service; and the TPV computer has means for transmitting a Unique Identifier code to the MCD, means for verifying whether the Unique Identifier code received from the SP computer is the same as the Unique Identifier code sent to the MCD and means for transmitting a Unique Identifier verification message to the SP computer.

### DETAILED DESCRIPTION OF THE INVENTION

The invention will be more clearly understood from the following description of some embodiments thereof, given by way of example only with reference to the accompanying drawings, in which:

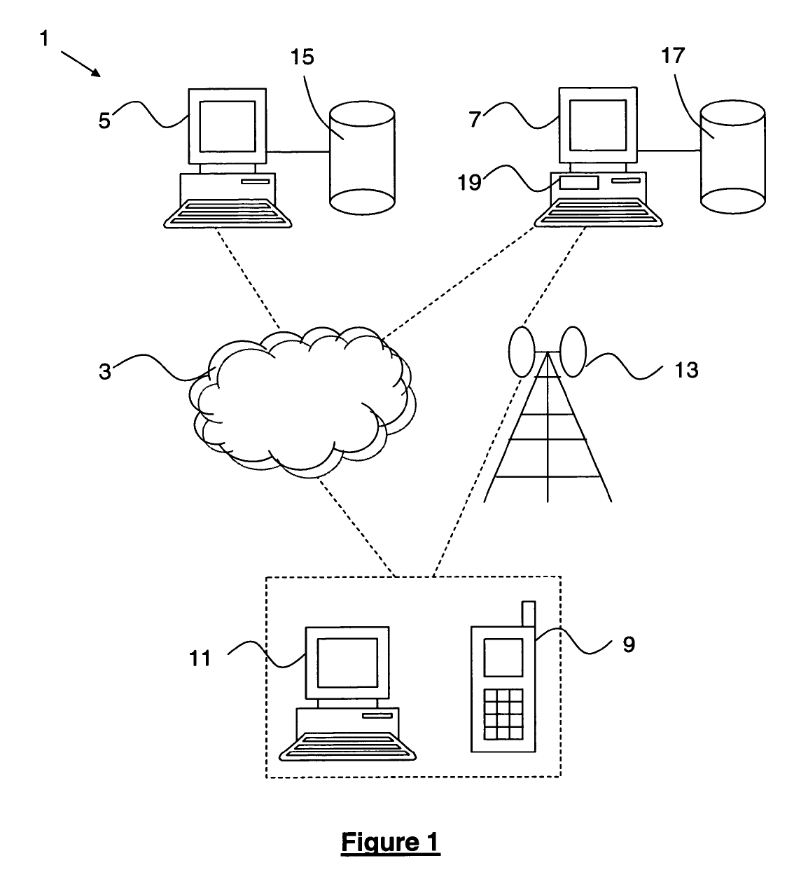

FIG. 1 is a diagrammatic representation of a system in which the method according to the invention may be carried out; and

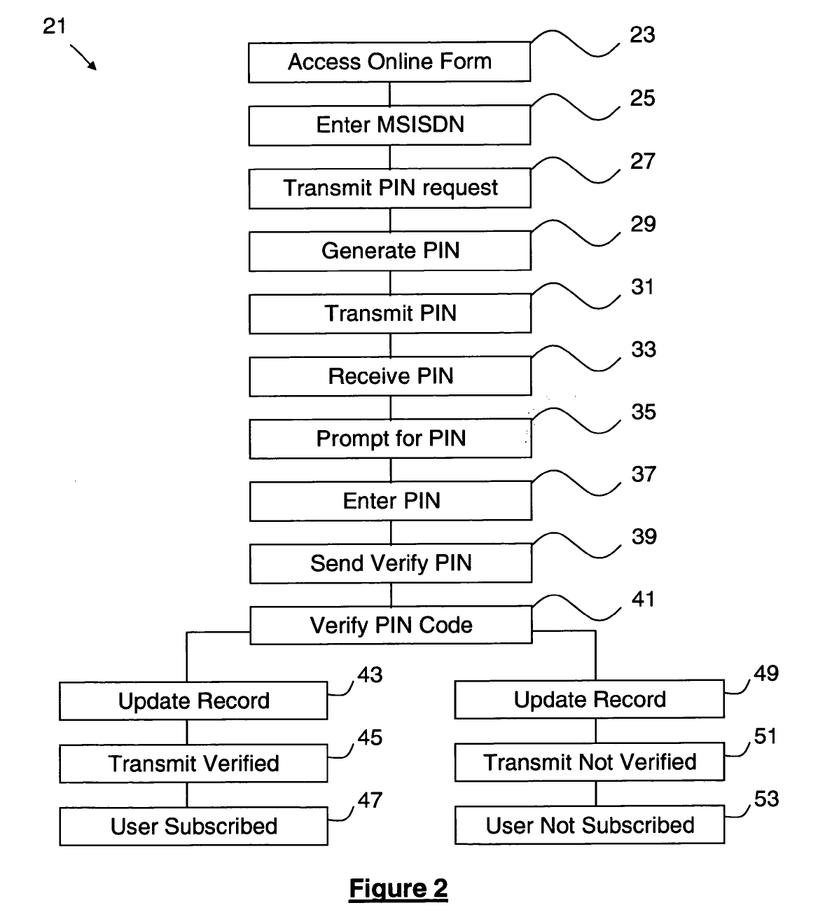

FIG. 2 is a flow diagram detailing the steps of the method according to the invention.

Referring to FIG. 1, there is shown a system in which the method according to a first embodiment of the invention may be carried out, indicated generally by the reference numeral 1 comprising a communication network, in this case the Internet 3, a service provider (SP) computer 5, an independent third party Unique Identifier verifier (TPV) computer 7 and a mobile communication device (MCD) 9. There is further provided a MCD user computer 11 and a mobile telephony network 13 capable of relaying SMS messages. The SP 5 comprises an accessible memory 15 and the TPV 7 comprises an accessible memory 17 and a Unique Identifier code generator 19. In the embodiment shown only one SP, one TPV and one MCD are shown for clarity. However it will be understood that there may be provided numerous SPs, TPVs and MCDs and their associated equipment. Furthermore, there may be provided multiple mobile telephony networks, however only one is shown for clarity.

The MCD 9 is shown accompanied by an MCD computer 11 that is able to access the SP through the Internet 3. However, it is envisaged that the MCD computer 11 may be unnecessary and in certain cases the MCD 9 may access the SP computer 5 directly through the Internet 3.

Referring now to FIG. 2, there is shown a flow diagram of the method according to the invention, indicated generally by the reference numeral 21. In step 23 a MCD user visits a SP's website promoting a particular mobile subscriber service or range of mobile subscriber services. In order to do this they may use their MCD 9 or the MCD computer 11. In step 25, the MCD user attempts to subscribe to the mobile content service by entering their details into an on-line form provided by the SP. As part of their details, the MCD user enters their MCD identifier, in this case the MSISDN. The MCD identifier could alternatively be any MCD identifier that allows the MCD to be contacted using that identifier including an MCD number or an IP address according to the ENUM or like system. In step 27, the SP computer 5 transmits a Unique Identifier request to the TPV computer 7. The Unique Identifier request comprises a transaction identifier, the MCD identifier (the MSISDN), a brief description of the service that the MCD user wishes to subscribe to and a specific string of text to be sent to the MCD user including a Unique Identifier code place holder.

In step 29, the TPV computer 7 uses the Unique Identifier code generator 19 to generate a Unique Identifier code for insertion into the string of text. Preferably, the Unique Identifier code will comprise a four digit numerical PIN. In step 31 the TPV 7 inserts the four digit Unique Identifier into the string and transmits an SMS message with the string incorporating the four digit Unique Identifier to the MCD using the supplied MCD identifier over the mobile telephony network 13. The TPV computer 7 logs a database record in memory 17 of the transaction to support later queries. The database record includes the transaction ID, the Unique Identifier request, an indication of the SP that the Unique Identifier request was received from, the date and time, the Unique Identifier inserted into the string and confirmation of transmission of the SMS with Unique Identifier to the MCD. It will be understood that other information may be stored as part of the database record, such as, but not limited to, a screenshot of the subscription screen. In step 33 the MCD 9 receives the Unique Identifier from the TPV computer 7 and in step 35 the SP website prompts the MCD user to enter the Unique Identifier. In step 37, the MCD enters the Unique Identifier into the on-line form.

In step 39, the SP website having received the Unique Identifier code from the MCD user sends a Unique Identifier verification request to the TPV computer 7 including the MCD identifier (the MSISDN) and the Unique Identifier received from the MCD user. The transaction identifier may also be retrieved from memory 15 and sent to the TPV computer 7. On receipt of the Unique Identifier verification request, the TPV computer 7 attempts to verify the Unique Identifier code in step 41 by retrieving the record stored in memory 17 of the transaction including the Unique Identifier that was sent to the MCD and comparing the Unique Identifier code received from the SP with the record of the Unique Identifier code sent to the MCD.

If, in step 41, the Unique Identifier code received from the SP matches the Unique

Identifier code that was sent to the MCD, the method proceeds to step 43 in which the TPV computer 7 updates the record in memory 17 to indicate that the Unique Identifier code has been verified. This updated record may be used to satisfy any subsequent queries made by a regulator. Thereafter, in step 45, the TPV computer 7 confirms to the SP computer 5 that the Unique Identifier codes are a match and in step 47 the MCD 9 is subscribed to the service by the SP.

If, however, at step 41 the TPV computer 7 determines that the Unique Identifier code received from the SP computer 5 is not a match to the Unique Identifier code sent to the MCD 9, the TPV computer 7 updates the transaction record stored in memory 17 to indicate that the Unique Identifier code is not verified. This updated record may be used to satisfy any subsequent queries made by a regulator. In step 51 the TPV computer 7 informs the SP computer 5 that the Unique Identifier codes are not a match and in step 53, the MCD 9 is not subscribed to the service by the SP. By having such a method, there will be an auditable third party Unique Identifier verification process which will be acceptable to the respective regulatory bodies and mobile operators. Furthermore, this method will not require the MCD user to confirm purchase of a service by switching to another technology platform. In addition to this, the method described will reduce the incidences of spamming and the adverse knock-on effects of data entry error.

Throughout the specification, reference is made to a method of authenticating a “subscription” to a Mobile Content Service. A “subscription” will be understood to include an isolated once-off transaction such as the purchase of a ring tone as well as a contract for multiple purchases and multiple periodic purchases of content such as a subscription to a service that provides content on a substantially continuous, daily, weekly, monthly or other periodic basis.

In the embodiment described the Unique Identifier is a four digit PIN. However, it is envisaged that the Unique Identifier may be numeric, alphabetical or alphanumeric and may be of arbitrary length. What is important is that a unique identifier is sent to the MCD for onwards transmittal to the SP and verification by the TPV computer. Instead of a MSISDN, it is conceivable that a MCD number, a Media Access Control (MAC) address or an IP address could be used in its stead.

Various modifications to the method and apparatus described above could be made within the scope of the present invention. For example, reference is made to entering the Unique Identifier into an online form however this may not always be necessary. There are many ways in which the Unique Identifier can be provided by the MCD user to the Service Provider. For example, the Unique Identifier may be provided by the MCD user over the mobile internet using their MCD handset. The Unique Identifier could be sent to an email address if provided. Alternatively, the Unique Identifier may be provided embedded in a WAP link and in order to submit the Unique Identifier, the MCD user simply “clicks” on the WAP link in the known manner which in turn will cause the Unique Identifier to be passed on to the SP. The SP will in turn then be able to pass the Unique Identifier received from the MCD to the TPV computer for verification.

When operating in a WAP environment, the TPV will encode the MSISDN and the Unique Identifier before sending these on to the MCD user. The MCD user will forward the encoded MSISDN and Unique Identifier to the SP that will be able to decode the MSISDN and Unique Identifier using an algorithm agreed with the TPV.

In the embodiment described, the Unique Identifier is transferred to the MCD in an SMS message however it will be readily understood that the Unique Identifier may be transferred using other technologies and the present invention is not solely limited to the use of SMS technology. For example, the Unique Identifier could be transferred via a WAP link, email, instant messaging or other technology. In such an instance, it may not be necessary to provide the mobile telephony network 13 for implementation of the method according to the invention and in some instances all communications could be routed through a single communication network such as the internet or other communication networks.

In the example provided, the MCD user provides their MCD identifier by entering it into an online form. However, this could be achieved in other ways such as automatic retrieval of their MCD identifier from an address book on a given user action taking place. For example, it is envisaged that the user could be logged into their social networking site account, for example, their Facebook (Registered Trade Mark) account and a banner advertisement would appear on the web page offering the MCD user mobile content. The MCD user could click on the banner advertisement thereby invoking a program associated with the banner advertisement, with the MCD user's permission, to automatically retrieve the MCD user's MCD identifier stored in an address book or other location of their social networking site account. Alternatively, the user action could comprise the user initiating a telephone call using their MCD to a mobile content service provider.

It is further envisaged that the TPV computer may implement a maximum verification attempt limit in order to obviate the possibility of fraud by the SP. For example, the SP may only be allowed three iterations to provide a Unique Identifier for verification of a transaction. If the incorrect Unique Identifier is provided by the SP on each occasion, the transaction will be cancelled or the SP will be prevented from entering a Unique Identifier for a predetermined period of time.

It will be further understood that the method according to the present invention will be performed largely in software and therefore the present invention extends also to computer programs, on or in a carrier, comprising program instructions for causing a computer to carry out the method. The computer program may be in source code format, object code format or a format intermediate source code and object code. The computer program may be stored on or in a carrier including any computer readable medium, including but not limited to a floppy disc, a CD, a DVD, a memory stick, a tape, a RAM, a ROM, a PROM, an EPROM, or a hardware circuit. The computer program may be provided in a cloud computing implementation as opposed to stored on a single specific device and either or both the SP and the TPV may be hosted in a cloud environment.

In a further embodiment, the computer program may be embodied on a transmissible carrier such as a carrier signal when transmitted either wirelessly and/or through wire and/or cable. The MCD computer will be understood to encompass a broad range of computing devices including but not limited exclusively to a personal computer (PC), a laptop, a netbook, a personal digital assistant, an iPad®, a handheld device such as a mobile phone, Blackberry®, iPhone® or other mobile computing device. The SP computer and the TPV computer will be understood to encompass a broad range of computing devices including but not limited exclusively to a personal computer (PC), a laptop, a netbook or a server.

In the specification the terms “comprise, comprises, comprised and comprising” and the terms “include, includes, included and including” are all deemed totally interchangeable and should be afforded the widest possible interpretation.

The invention is in no way limited to the embodiment hereinbefore described which may be varied in both construction and detail within the scope of the appended claims.

1. A method of authenticating subscription to a mobile content service in a system comprising a Service Provider (SP) computer, an independent Third Party Verifier (TPV) computer and a Mobile Communication Device (MCD), the method comprising the steps of:
an MCD user submitting a MCD identifier to an SP;
the SP computer transmitting a Unique Identifier code request incorporating the MCD identifier to the TPV computer;
the TPV computer transmitting a Unique Identifier code to the MCD;
the MCD user forwarding the Unique Identifier code to the SP computer;
the SP computer transmitting the MCD identifier and the Unique Identifier code to the TPV computer for authentication of the Unique Identifier code;
the TPV computer verifying whether the Unique Identifier code received from the SP computer is the same as the Unique Identifier code sent to the MCD and if so the TPV computer transmitting a Unique Identifier verification message to the SP computer; and
on the SP computer receiving a Unique Identifier verification message, the SP computer subscribing the MCD to the mobile content service.

2. The method as claimed in claim 1 in which, in addition to the MCD identifier, the SP computer transmits a string of text including a Unique Identifier placeholder, as part of the Unique Identifier code request.

3. The method as claimed in claim 2 in which the step of the TPV computer transmitting a Unique Identifier code to the MCD further comprises the steps of:
the TPV computer inserting the Unique Identifier code into the Unique Identifier placeholder in the string of text; and
forwarding the string of text with the Unique Identifier code to the MCD.

4. The method as claimed in claim 1 in which, in addition to the MCD identifier, the SP computer transmits at least one of a transaction ID and a description of the mobile content service, as part of the Unique Identifier code request.

5. The method as claimed in claim 4 in which the TPV computer creates a log of the event including: a transaction ID, the Unique Identifier code request, an SP computer identifier, a time/date stamp, the Unique Identifier code and a record of transmission of the Unique Identifier code to the MCD.

6. The method as claimed in claim 5 in which on the TPV computer verifying that the Unique Identifier code received from the SP computer is the same as the Unique Identifier code sent to the MCD, the TPV computer updates the log of the event with an indication of Unique Identifier verified status.

7. The method as claimed in claim 4 in which the step of the SP computer transmitting the Unique Identifier code to the TPV computer for authentication further comprises the SP computer transmitting, along with the Unique Identifier code, the transaction ID instead of or in addition to the MCD identifier to the TPV computer.

8. The method as claimed in claim 1 in which the TPV computer transmits the Unique Identifier code to the MCD in a Short Messaging Service (SMS) message.

9. The method as claimed in claim 1 in which the MCD user submits the MCD identifier by entering the MCD identifier into an SP online foil 1.

10. The method as claimed in claim 9 in which the step of the MCD forwarding the Unique Identifier code to the SP computer comprises the MCD user entering the Unique Identifier code into the SP online form.

11. The method as claimed in claim 1 in which the step of the MCD user forwarding the Unique Identifier code to the SP computer further comprises the MCD user forwarding their MSISDN to the SP along with the Unique Identifier code.

12. The method as claimed in claim 11 in which the MSISDN and the Unique Identifier are encrypted prior to transmission to the SP.

13-17. (canceled)

18. A method of authenticating subscription to a mobile content service in a system comprising an independent Third Party Verifier (TPV) computer, a remote service provider (SP) computer, and a remote mobile communication device (MCD), the method comprising the steps of:
the TPV computer receiving a Unique Identifier code request incorporating an MCD identifier from the remote SP computer;
the TPV computer transmitting a Unique Identifier code to the remote MCD;
the TPV computer receiving the MCD identifier and the Unique Identifier code from the remote SP computer for authentication of the Unique Identifier code; and
the TPV computer verifying whether the Unique Identifier code received from the remote SP computer is the same as the Unique Identifier code sent to the remote MCD and if so the TPV computer transmitting a Unique Identifier verification message to the remote SP computer.

19. The method as claimed in claim 18 in which, in addition to the MCD identifier, the TPV computer receives a string of text including a Unique Identifier placeholder, as part of the Unique Identifier code request.

20. The method as claimed in claim 19 in which the step of the TPV computer transmitting a Unique Identifier code to the remote MCD further comprises the steps of:
the TPV computer inserting the Unique Identifier code into the Unique Identifier placeholder in the string of text; and
forwarding the string of text and Unique Identifier code to the remote MCD.

21. The method as claimed in claim 18 in which, in addition to the MCD identifier, the TPV computer receives at least one of a transaction ID and a description of the mobile content service, as part of the Unique Identifier code request.

22. The method as claimed in claim 21 in which the TPV computer creates a log of the event including: the transaction ID, the Unique Identifier code request, a remote SP computer identifier, a time/date stamp, the Unique Identifier code and confirmation of transmission of the Unique Identifier code to the remote MCD.

23. The method as claimed in claim 22 in which on the TPV computer verifying that the Unique Identifier code received from the remote SP computer is the same as the Unique Identifier code sent to the remote MCD, the TPV computer updates the log of the event with an indication of Unique Identifier verified status.

24. The method as claimed in claim 21 in which the step of the TPV computer receiving the Unique Identifier code from the remote SP computer for authentication further comprises the TPV computer receiving, along with the Unique Identifier code, a transaction ID instead of or in addition to the MCD identifier from the remote SP computer.

25. The method as claimed in claim 18 in which the TPV computer transmits a Unique Identifier code to the remote MCD in a Short Messaging Service (SMS) message.

26-29. (canceled)

30. A system for authenticating subscription to a mobile content service comprising a Service Provider (SP) computer, an independent Third Party Verifier (TPV) computer and a Mobile Communication Device (MCD), in which
the MCD has means for submitting a MCD identifier and forwarding a Unique Identifier code to the SP computer;
the SP computer has means for transmitting a Unique Identifier code request incorporating the MCD identifier to the TPV computer, means for transmitting the MCD identifier and the Unique Identifier code to the TPV computer for authentication of the Unique Identifier code and means for subscribing the MCD to the mobile content service; and
the TPV computer has means for transmitting a Unique Identifier code to the MCD, means for verifying whether the Unique Identifier code received from the SP computer is the same as the Unique Identifier code sent to the MCD and means for transmitting a Unique Identifier verification message to the SP computer.
